(19) United States
(12) Patent Application Publication
(10) Pub. No.: US 2016/0300272 A1
(43) Pub. Date: Oct. 13, 2016

(54) CDN-BASED ADVERTISEMENT MATERIAL DOWNLOAD METHOD, APPARATUS, AND DEVICE

(71) Applicant: LECLOUD COMPUTING CO., LTD., Beijing (CN)

(72) Inventors: Weibo AO, Beijing (CN); Luqi LI, Beijing (CN); Yang SHEN, Beijing (CN); Yusheng ZHANG, Beijing (CN); Zhigang LI, Beijing (CN)

(21) Appl. No.: 15/037,700

(22) PCT Filed: Nov. 10, 2014
(86) PCT No.: PCT/CN2014/090746

§ 371 Date: May 19, 2016

(30) Foreign Application Priority Data
Nov. 20, 2013 (CN) 201310589983.2

(51) Int. Cl. G06Q 30/02; H04L 29/08

(52) U.S. Cl. CPC G06Q 30/0277; H04L 67/02

(57) ABSTRACT

The present invention discloses a CDN-based advertisement material download method, apparatus, and device, the method comprising: receiving an instruction to download advertisement material and acquiring from said instruction an advertisement material identifier; reading the local flash cookie, and, on the basis of the advertisement material identifier, acquiring from the flash cookie a corresponding scheduling address and determining whether an actual download address is stored within said corresponding scheduling address; if yes, then acquiring from the flash cookie the actual download address of the advertisement material and, on the basis of the actual download address, directly reading the advertisement material in a browser cache; if no, then requesting from a CDN server acquisition of the actual download address of the advertisement material, and, on the basis of the acquired actual download address, downloading the advertisement material. The present method reduces the failure rate of advertisement material download, increases the average download speed of advertisement material, and improves advertisement inventory utilization.

### CROSS-REFERENCE TO RELATED APPLICATIONS

This application is a US National Stage of International Application No. PCT/CN2014/090746, filed Nov. 10, 2014, designating the United States, and claiming the benefit of Chinese Patent Application No. 201310589983.2, filed with the State Intellectual Property Office of People's Republic of China on Nov. 20, 2013 and entitled “Method for downloading an advertisement material over a CDN”, the content of which is hereby incorporated by reference in its entirety.

### FIELD

The present disclosure relates to a method for downloading an advertisement material and particularly to a method, apparatus and device for downloading an advertisement material over a Content Delivery Network (CDN).

### BACKGROUND

An advertisement material is currently downloaded in the industry generally in the following two schemes: in one scheme, a client initiates a request to a Domain Name System (DNS) server at a static address, and the DNS server parses the request for a specified server node, so that the client obtains an advertisement material from the specified server node, and buffers the advertisement material locally after the advertisement material is downloaded; and in the other scheme, a client initiates a request to a scheduling server at a scheduled address, and the scheduling server redirects the request to a specified server node, so that the client obtains an advertisement material from the specified server node.

The first download scheme is disadvantageous in that the client is so overly dependent upon the DNS server that if the server node determined by the parsing DNS server is unavailable, then the client may fail to load the advertisement material, thus degrading the success ratio of downloading the advertisement material. The second download scheme is disadvantageous in that the buffer of the client can not be utilized, for example, if the client initiates the request to the scheduled address A, then the scheduling server redirects the request to a real download address B, so that some advertisement material is downloaded at the download address, and the downloaded advertisement material is buffered; and however if the advertisement material needs to be played next time, then even if the client initiates a request to the scheduling server at the same scheduled address A, then the address of a server node to which the scheduling server redirects the request may not be the real download address B, but the address of the server node to which the request is redirected may be different, so that even if the same advertisement material is to be downloaded, then the advertisement material lastly buffered at the client may not be utilized, so the advertisement material has to be downloaded again each time, thus increasing the number of times that the advertisement material is downloaded, which may degrade the average speed at which the advertisement material is downloaded.

### SUMMARY

Embodiments of the present disclosure provide a method, apparatus and device for downloading an advertisement material over a CDN so as to improve the success ratio, and the average speed, at which the advertisement material is downloaded.

Particular technical solutions according to the embodiments of the present disclosure are as follows:

In a first aspect, a method for downloading an advertisement material over a CDN includes:
receiving an instruction for downloading the advertisement material, and to obtain an identifier of the advertisement material from the instruction;
reading a local flash cookie, obtaining a scheduled address corresponding to the identifier in the flash cookie according to the identifier of the advertisement material, and determining whether there is a real download address stored corresponding to the scheduled address; and
if there is a real download address stored corresponding to the scheduled address, then obtaining the real download address of the advertisement material from the flash cookie, and reading the advertisement material directly in a buffer of a browser at the real download address;
if there is not a real download address stored corresponding to the scheduled address, requesting a CDN server for obtaining the real download address of the advertisement material, and downloading the advertisement material at the real download address obtained.

Thus the reliable CDN can be applied together with the buffer of the browser and the storage capacity of the flash cookie in the client so that the failure ratio of downloading the advertisement material can be lowered, and the average speed of downloading the advertisement material can be improved.

In connection with the first aspect, in a first possible implementation, requesting the CDN server for obtaining the real download address of the advertisement material, and downloading the advertisement material at the real download address obtained includes:
obtaining a list of real download addresses of the advertisement material; and
downloading the advertisement material at the address of a CDN node at the highest priority in the list of real download addresses.

Thus the CDN server will obviate as much as possible a bottleneck and a node over the Internet, which may degrade the speed and stability of data transmission, and redirect the request of the user to a service node in a network state optimum for the user to thereby address the congestion over the Internet and improve the response speed.

In connection with the first possible implementation of the first aspect, in a second possible implementation, after the advertisement material is downloaded at the address of the CDN node at the highest priority in the list of real download addresses, the method further includes:
determining whether the advertisement material is downloaded successfully, and if the advertisement material is downloaded successfully, then storing the advertisement material in the buffer of the browser, and modifying the contents of the flash cookie;
if the advertisement material is downloaded unsuccessfully, downloading the advertisement material sequentially at the addresses of the CDN nodes in the list of real download addresses in the descending order of their priorities starting from the address of the CDN node at the second highest priority in the list of real download addresses until the advertisement material is downloaded successfully, stopping the advertisement material from being downloaded, storing the advertisement material in the buffer of the browser, and modifying the contents of the flash cookie.

With this retry mechanism, the success ratio of downloading the advertisement material can be improved.

In connection with the second possible implementation of the first aspect, in a third possible implementation, if the advertisement material is downloaded successfully, then modifying the contents of the flash cookie includes:
storing a correspondence relationship between the scheduled address corresponding to the advertisement material, and the address of the CDN node from which the advertisement material is downloaded successfully, in the flash cookie.

Thus if the same advertisement material is downloaded later, then the corresponding real download address will be obtained in the flash cookie at the scheduled address, and further the advertisement material will be obtained directly in the buffer of the browser at the real download address, instead of downloading again the advertisement material.

In connection with the first possible implementation of the first aspect, in a fourth possible implementation, the list of real download addresses of the advertisement material includes the addresses of three CDN nodes at the highest priorities returned by the CDN server; and
the addresses of the three CDN nodes at the highest priorities are set according to a network state, and sorted in the list of real download addresses in a descending order of their priorities, wherein the network state indicates network operating conditions of the respective CDN nodes.

In this implementation, the addresses of the three CDN nodes in the best network states can be returned to thereby greatly improve the average speed of downloading the advertisement material.

In a second aspect, an apparatus for downloading an advertisement material over a CDN includes:
one or more processor; and
a memory, wherein:
   one or more computer readable program codes are stored in the memory, and the one or more processors are configured to perform the one or more computer readable program codes to perform:
receiving an instruction for downloading the advertisement material, and obtaining an identifier of the advertisement material from the instruction;
reading a local flash cookie, obtaining a scheduled address corresponding to the identifier in the flash cookie according to the identifier of the advertisement material, and determining whether there is a real download address stored corresponding to the scheduled address;
if there is a real download address stored corresponding to the scheduled address, then obtaining the real download address of the advertisement material from the flash cookie, and to read the advertisement material directly in a buffer of a browser at the real download address; and
if there is not a real download address stored corresponding to the scheduled address, requesting a CDN server for obtaining the real download address of the advertisement material, and downloading the advertisement material at the obtained real download address.

Thus the reliable CDN can be applied together with the buffer of the browser and the storage capacity of the flash cookie in the client so that the failure ratio of downloading the advertisement material can be lowered, and the average speed of downloading the advertisement material can be improved.

In connection with the second aspect, in a first possible implementation, the one or more processors are further configured to perform the one or more computer readable program codes to perform:
obtaining a list of real download addresses of the advertisement material; and
downloading the advertisement material at the address of a CDN node at the highest priority in the list of real download addresses.

Thus the downloading unit can initiate a request to the CDN server, so that the CDN server will obviate as much as possible a bottleneck and a node over the Internet, which may degrade the speed and stability of data transmission, and redirect the request of the user to a service node in a network state optimum for the user to thereby address the congestion over the Internet and improve the response speed.

In connection with the first possible implementation of the second aspect, in a second possible implementation, the one or more processors are further configured to perform the one or more computer readable program codes to perform:
determining whether the advertisement material is downloaded successfully after the advertisement material is downloaded at the address of the CDN node at the highest priority in the list of real download addresses, and if one or more computer programs are further configured to be executed by the one or more processors to perform, storing the advertisement material in the buffer of the browser, and modifying the contents of the flash cookie; if the advertisement material is downloaded unsuccessfully, downloading the advertisement material sequentially at the addresses of the CDN nodes in the list of real download addresses in the descending order of their priorities starting from the address of the CDN node at the second highest priority in the list of real download addresses until the advertisement material is downloaded successfully, stopping the advertisement material from being downloaded, storing the advertisement material into the buffer of the browser, and modifying the contents of the flash cookie.

With this retry mechanism of the downloading unit, the success ratio of downloading the advertisement material can be improved.

In connection with the second possible implementation of the second aspect, in a third possible implementation, the one or more processors are further configured to perform the one or more computer readable program codes to perform:
storing a correspondence relationship between the scheduled address corresponding to the advertisement material, and the address of the CDN node from which the advertisement material is downloaded successfully, in the flash cookie.

Thus if the same advertisement material is downloaded later, then the reading unit will obtain the corresponding real download address in the flash cookie at the scheduled address, and further obtain the advertisement material directly in the buffer of the browser at the real download address, instead of downloading again the advertisement material.

In connection with the first possible implementation of the second aspect, in a fourth possible implementation, the list of real download addresses of the advertisement material includes the addresses of three CDN nodes at the highest priorities returned by the CDN server; and
the addresses of the three CDN nodes at the highest priorities are set according to a network state, and sorted in the list of real download addresses in a descending order of their priorities, wherein the network state indicates network operating conditions of the respective CDN nodes.

In this implementation, the addresses of the three CDN nodes in the best network states can be returned to thereby greatly improve the average speed of downloading the advertisement material.

In a third aspect, a client device including the apparatus above for downloading an advertisement material over a CDN.

### BRIEF DESCRIPTION OF THE DRAWINGS

FIG. 1 is a particular flow chart of downloading by a client an advertisement material according to an embodiment of the present disclosure;

FIG. 2 is a schematic diagram of a system for downloading by a client an advertisement material according to an embodiment of the present disclosure; and

FIG. 3 is a structural diagram of an apparatus for downloading an advertisement material over a CDN according to an embodiment of the present disclosure.

### DETAILED DESCRIPTION OF THE EMBODIMENTS

In order to improve the success ratio, and the average speed, at which an advertisement material is downloaded, embodiments of the present disclosure provide a method, apparatus and device for downloading an advertisement material over a CDN to thereby address in effect the drawbacks of the schemes to download an advertisement material in the prior art.

Preferred embodiments of the present disclosure will be described below in details with reference to the drawings.

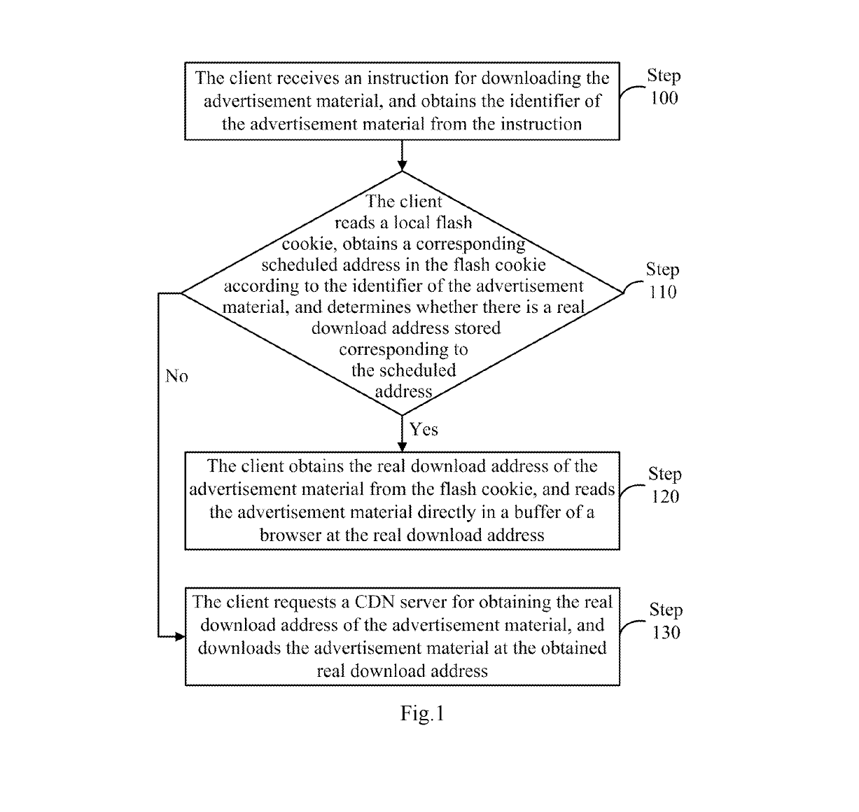

Referring to FIG. 1, in an embodiment of the present disclosure, a client downloads an advertisement material in the following particular flow:

In the operation 100, the client receives an instruction for downloading the advertisement material, and obtains an identifier of the advertisement material from the instruction.

In the operation 110, the client reads a local flash cookie, obtains a scheduled address corresponding to the identifier in the flash cookie according to the identifier of the advertisement material, and determines whether there is a real download address stored corresponding to the scheduled address, and if there is a real download address stored corresponding to the scheduled address, then the flow proceeds to the operation 120; if there is not a real download address stored corresponding to the scheduled address, the flow proceeds to the operation 130.

In the operation 120, the client obtains the real download address of the advertisement material from the flash cookie, and reads the advertisement material directly in a buffer of a browser at the real download address.

In the operation 130, the client requests a CDN server for obtaining the real download address of the advertisement material, and downloads the advertisement material at the real download address obtained.

For example, in an embodiment of the present disclosure, the client can obtain a list of real download addresses of the advertisement material, and download the advertisement material at the address of a CDN node at the highest priority in the list of real download addresses, where the list of real download addresses of the advertisement material can include the addresses of three CDN nodes at the highest priorities returned by the CDN server, the priorities of the addresses of the three CDN nodes are set according to real-time network states of the respective CDN nodes, e.g., network traffic of the respective CDN nodes, connection and load conditions of the respective CDN nodes, the distances from the respective CDN nodes to the user, response times, and other integrated information, and the addresses are arranged in the list of real download addresses in a descending order of their priorities.

Furthermore the client determines whether the advertisement material is downloaded successfully, and if the advertisement material is downloaded successfully, then the client stores the advertisement material in the buffer of the browser, and modifies the contents of the flash cookie, that is, stores a correspondence relationship between the scheduled address corresponding to the advertisement material, and the address of the CDN node from which the advertisement material is downloaded successfully, in the flash cookie; if the advertisement material is downloaded unsuccessfully, the client downloads the advertisement material sequentially at the addresses of the CDN nodes in the list of real download addresses in the descending order of their priorities starting from the address of the CDN node at the second highest priority in the list of real download addresses until the advertisement material is downloaded successfully, stops the advertisement material from being downloaded, stores the advertisement material in the buffer of the browser, and modifies the contents of the flash cookie. If the client fails to download the advertisement material after traversing all the addresses of the CDN nodes in the list of real download addresses, then the client will give up downloading the advertisement material.

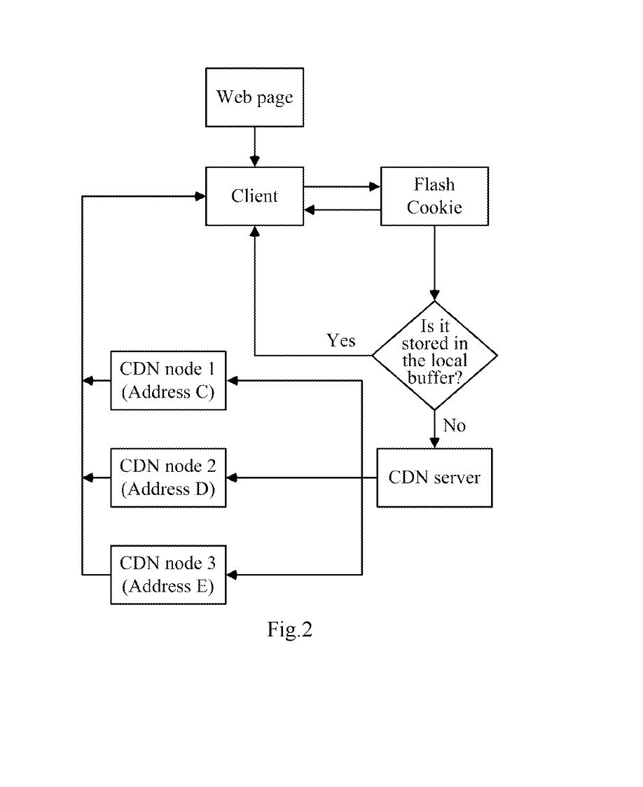

Further to the embodiment above, referring to FIG. 2, if some advertisement material (identified as A) is not buffered in the local browser, for example, then the client will download the advertisement material in the following detailed process:

If some advertisement material A is played on a webpage, then the client will receive an instruction to download the advertisement material A. The client reads a local flash cookie according to the identifier A of the advertisement material, obtains a scheduled address B corresponding to the advertisement material A, and extracts the value of a real download address using the scheduled address B as a key, and as depicted in Table 1, since the advertisement material A has not ever been downloaded, the value of the real download address in the flash cookie, corresponding to the scheduled address B is null, that is, the advertisement material A is not buffered in the local browser.

TABLE 1

| Identifier of advertisement | Scheduled | Real download address |
|---|---|---|
| material | address (key) | (value) |
| A | B | |

Next the client initiates a request to the CDN server at the scheduled address B. The CDN server will obviate as much as possible a bottleneck and a link which may degrade the speed and stability of data transmission, and return a list of real download addresses including the addresses of three CDN nodes at the highest priorities, i.e., the address C, the address D and the address E corresponding to the node 1, the node 2 and the node 3, according to a network environment where the user is located, e.g., network traffic of the respective CDN nodes, connection and load conditions of the respective CDN nodes, the distances from the respective CDN nodes to the user, response times, and other integrated information, where the priority of the address C of the node 1 is higher than that of the address D of the node 2, and the priority of the address D of the node 2 is higher than that of the address E of the node 3. The client firstly starts to attempt to download the advertisement material A from the address of the node at the highest priority, i.e., the address C of the node 1, and if the advertisement material A is not downloaded successfully, then the client attempts again to download the advertisement material A from the address of the node at the second highest priority, i.e., the address D of the node 2, and so on. If the client downloads the advertisement material A successfully at the address D of the node 2, then firstly the browser will buffer the advertisement material A, and also the client will store a piece of data into a list of advertisement material addresses of the flash cookie using the scheduled address B as a key, and as the value the address D of the node 2 from which the advertisement material A is downloaded successfully, as depicted in Table 2. Thus if the advertisement material is played later, then if the scheduled address of the advertisement material is determined as B, then the client will not send a schedule request to the CDN server, but will extract the real download address D directly from the list of advertisement material addresses of the flash cookie using the scheduled address B as the key, and further obtain and play the file of the advertisement material from the buffer of the browser at the real download address D.

TABLE 2

| Identifier of advertisement | Scheduled | Real download address |
|---|---|---|
| material | address (key) | (value) |
| A | B | D |

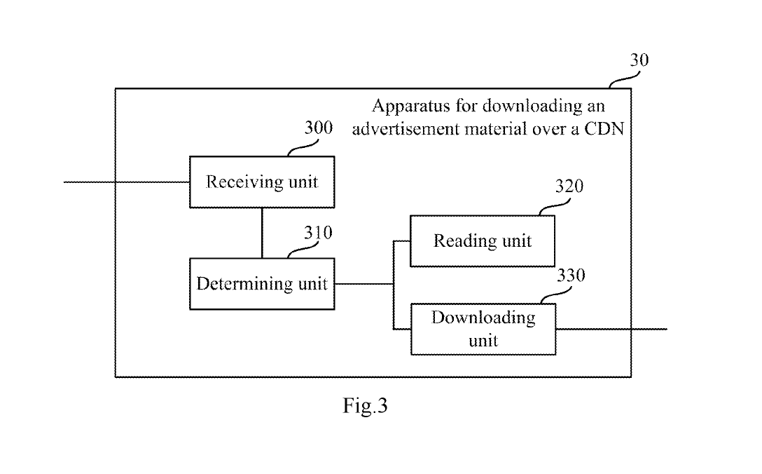

Referring below to FIG. 3, a structure of an apparatus 30 for downloading an advertisement material over a CDN according to an embodiment of the present disclosure will be described in details.

A receiving unit 300 is configured to receive an instruction for downloading the advertisement material, and to obtain an identifier of the advertisement material from the instruction.

A determining unit 310 is configured to read a local flash cookie, to obtain a scheduled address corresponding to the identifier in the flash cookie according to the identifier of the advertisement material, and to determine whether there is a real download address stored corresponding to the scheduled address.

A reading unit 320 is configured to obtain the real download address of the advertisement material from the flash cookie, and to read the advertisement material directly in a buffer of a browser at the real download address, if the determining unit 310 determines that there is the real download address stored corresponding to the scheduled address; and

A downloading unit 330 is configured to request a CDN server for obtaining the real download address of the advertisement material, and to download the advertisement material at the real download address obtained, when the determining unit 310 determines that there is no real download address stored corresponding to the scheduled address.

In an embodiment of the present disclosure, the downloading unit 330 is configured to obtain a list of real download addresses of the advertisement material, and to download the advertisement material at the address of a CDN node at the highest priority in the list of real download addresses.

In an embodiment of the present disclosure, the list of real download addresses of the advertisement material includes the addresses of three CDN nodes at the highest priorities returned by the CDN server, where the addresses of the three CDN nodes at the highest priorities are set according to a network state, and sorted in the list of real download addresses in a descending order of their priorities, wherein the network state indicates network operating conditions of the respective CDN nodes, e.g., network traffic of the respective CDN nodes, connection and load conditions of the respective CDN nodes, the distances from the respective CDN nodes to the user, response times, and other integrated information.

The downloading unit 330 is further configured to determine whether the advertisement material is downloaded successfully after the advertisement material is downloaded at the address of the CDN node at the highest priority in the list of real download addresses, and if the advertisement material is downloaded successfully, to store the advertisement material in the buffer of the browser, and to modify the contents of the flash cookie; if the advertisement material is downloaded unsuccessfully, to download the advertisement material sequentially at the addresses of the CDN nodes in the list of real download addresses in the descending order of their priorities starting from the address of the CDN node at the second highest priority in the list of real download addresses until the advertisement material is downloaded successfully, to stop the advertisement material from being downloaded, to store the advertisement material in the buffer of the browser, and to modify the contents of the flash cookie.

In an embodiment of the present disclosure, the downloading unit 330 configured to modify the contents of the flash cookie is configured to store a correspondence relationship between the scheduled address corresponding to the advertisement material, and the address of the CDN node from which the advertisement material is downloaded successfully, in the flash cookie.

An embodiment of the present disclosure further provides a client device for performing the method for downloading the advertisement material over a CDN as illustrated in FIG. 2, where the client device includes the apparatus for downloading the advertisement material over a CDN as illustrated in FIG. 3.

In summary, with the technical solutions according to the embodiments of the present disclosure, a number of available real material download addresses can be provided at a time over the reliable CDN, and the correspondence relationship between the scheduled addresses and the real download addresses can be stored in the flash cookie at the client; and the retry mechanism and the buffer of the browser can be applied as well, so that the failure ratio of downloading the advertisement material can be lowered, and the average speed of downloading the advertisement material can be improved, to thereby improve the utilization ratio of advertisements in stock. The technical solutions according to the embodiments of the present disclosure can handle successfully a number of abnormal conditions while downloading the advertisement material, where real tests demonstrated that the failure ratio of downloading the advertisement material can be lowered by a factor of ⅔, thus shortening the average period of time taken to download the advertisement so as to make the advertisement played more fluently.

Evidently those skilled in the art can make various modifications and variations to the present disclosure without departing from the spirit and scope of the present disclosure. Thus the present disclosure is also intended to encompass these modifications and variations thereto so long as the modifications and variations come into the scope of the claims appended to the present disclosure and their equivalents.

1. A method for downloading an advertisement material over a Content Delivery Network (CDN), the method comprising:
receiving an instruction for downloading the advertisement material, and to obtain an identifier of the advertisement material from the instruction;
reading a local flash cookie, obtaining a scheduled address corresponding to the identifier in the flash cookie according to the identifier of the advertisement material, and determining whether there is a real download address stored corresponding to the scheduled address; and
if there is a real download address stored corresponding to the scheduled address, then obtaining the real download address of the advertisement material from the flash cookie, and reading the advertisement material directly in a buffer of a browser at the real download address;
if there is not a real download address stored corresponding to the scheduled address, requesting a CDN server for obtaining the real download address of the advertisement material, and downloading the advertisement material at the real download address obtained.

2. The method according to claim 1, wherein requesting the CDN server for obtaining the real download address of the advertisement material, and downloading the advertisement material at the real download address obtained comprises:
obtaining a list of real download addresses of the advertisement material; and
downloading the advertisement material at the address of a CDN node at the highest priority in the list of real download addresses.

3. The method according to claim 2, wherein after the advertisement material is downloaded at the address of the CDN node at the highest priority in the list of real download addresses, the method further comprises:
determining whether the advertisement material is downloaded successfully, and if the advertisement material is downloaded successfully, then storing the advertisement material in the buffer of the browser, and modifying the contents of the flash cookie;
if the advertisement material is downloaded unsuccessfully, downloading the advertisement material sequentially at the addresses of the CDN nodes in the list of real download addresses in the descending order of their priorities starting from the address of the CDN node at the second highest priority in the list of real download addresses until the advertisement material is downloaded successfully, stopping the advertisement material from being downloaded, storing the advertisement material in the buffer of the browser, and modifying the contents of the flash cookie.

4. The method according to claim 3, wherein modifying the contents of the flash cookie comprises:
storing a correspondence relationship between the scheduled address corresponding to the advertisement material and the address of the CDN node from which the advertisement material is downloaded successfully, in the flash cookie.

5. The method according to claim 2, wherein the list of real download addresses of the advertisement material comprises the addresses of three CDN nodes at the highest priorities returned by the CDN server; and
the addresses of the three CDN nodes at the highest priorities are set according to a network state, and sorted in the list of real download addresses in a descending order of their priorities, wherein the network state indicates network operating conditions of the respective CDN nodes.

6. An apparatus for downloading an advertisement material over a Content Delivery Network (CDN), the apparatus comprising:
one or more processor; and
a memory, wherein:
one or more computer readable program codes are stored in the memory, and the one or more processors are configured to perform the one or more computer readable program codes to perform:
receiving an instruction for downloading the advertisement material, and to obtain an identifier of the advertisement material from the instruction;
reading a local flash cookie, obtaining a scheduled address corresponding to the identifier in the flash cookie according to the identifier of the advertisement material, and determining whether there is a real download address stored corresponding to the scheduled address; and
if there is a real download address stored corresponding to the scheduled address, then obtaining the real download address of the advertisement material from the flash cookie, and to read the advertisement material directly in a buffer of a browser at the real download address; and
if there is not a real download address stored corresponding to the scheduled address, requesting a CDN server for obtaining the real download address of the advertisement material, and downloading the advertisement material at the obtained real download address.

7. The apparatus according to claim 6, wherein the one or more processors are further configured to perform the one or more computer readable program codes to perform:
obtaining a list of real download addresses of the advertisement material; and
downloading the advertisement material at the address of a CDN node at the highest priority in the list of real download addresses.

8. The apparatus according to claim 7, wherein the one or more processors are further configured to perform the one or more computer readable program codes to perform:
determining whether the advertisement material is downloaded successfully after the advertisement material is downloaded at the address of the CDN node at the highest priority in the list of real download addresses, and if the advertisement material is downloaded successfully, storing the advertisement material in the buffer of the browser, and modifying the contents of the flash cookie; if the advertisement material is downloaded unsuccessfully, downloading the advertisement material sequentially at the addresses of the CDN nodes in the list of real download addresses in the descending order of their priorities starting from the address of the CDN node at the second highest priority in the list of real download addresses until the advertisement material is downloaded successfully, stopping the advertisement material from being downloaded, storing the advertisement material in the buffer of the browser, and modifying the contents of the flash cookie.

9. The apparatus according to claim 8, wherein the one or more processors are further configured to perform the one or more computer readable program codes to perform:
storing a correspondence relationship between the scheduled address corresponding to the advertisement material and the address of the CDN node from which the advertisement material is downloaded successfully, in the flash cookie.

10. The apparatus according to claim 7, wherein the list of real download addresses of the advertisement material comprises the addresses of three CDN nodes at the highest priorities returned by the CDN server; and
the addresses of the three CDN nodes at the highest priorities are set according to a network state, and sorted in the list of real download addresses in a descending order of their priorities, wherein the network state indicates network operating conditions of the respective CDN nodes.

11. A client device, comprising the apparatus for downloading an advertisement material over a Content Delivery Network (CDN), the apparatus comprising:
one or more processor; and
a memory, wherein:
one or more computer readable program codes are stored in the memory, and the one or more processors are configured to perform the one or more computer readable program codes to perform:
receiving an instruction for downloading the advertisement material, and to obtain the identifier of the advertisement material from the instruction;
reading a local flash cookie, obtaining a scheduled address corresponded to the identifier in the flash cookie according to the identifier of the advertisement material, and determining whether there is a real download address stored corresponding to the scheduled address; and
if there is a real download address stored corresponding to the scheduled address, then obtaining the real download address of the advertisement material from the flash cookie, and to read the advertisement material directly in a buffer of a browser at the real download address; and
if there is not a real download address stored corresponding to the scheduled address, requesting a CDN server for obtaining the real download address of the advertisement material, and downloading the advertisement material at the obtained real download address.

12. The client device according to claim 11, wherein the one or more processors are further configured to perform the one or more computer readable program codes to perform:
obtaining a list of real download addresses of the advertisement material; and
downloading the advertisement material at the address of a CDN node at the highest priority in the list of real download addresses.

13. The client device according to claim 12, wherein the one or more processors are further configured to perform the one or more computer readable program codes to perform:
determining whether the advertisement material is downloaded successfully after the advertisement material is downloaded at the address of the CDN node at the highest priority in the list of real download addresses, and if the advertisement material is downloaded successfully, storing the advertisement material in the buffer of the browser, and modifying the contents of the flash cookie; if the advertisement material is downloaded unsuccessfully, downloading the advertisement material sequentially at the addresses of the CDN nodes in the list of real download addresses in the descending order of their priorities starting from the address of the CDN node at the second highest priority in the list of real download addresses until the advertisement material is downloaded successfully, stopping the advertisement material from being downloaded, storing the advertisement material in the buffer of the browser, and modifying the contents of the flash cookie.

14. The client device according to claim 13, wherein the one or more processors are further configured to perform the one or more computer readable program codes to perform:
storing a correspondence relationship between the scheduled address corresponding to the advertisement material, and the address of the CDN node from which the advertisement material is downloaded successfully, in the flash cookie.

15. The client device according to claim 12, wherein the list of real download addresses of the advertisement material comprises the addresses of three CDN nodes at the highest priorities returned by the CDN server; and
the addresses of the three CDN nodes at the highest priorities are set according to a network state, and sorted in the list of real download addresses in a descending order of their priorities, wherein the network state indicates network operating conditions of the respective CDN nodes.
